(19) United States
(12) Patent Application Publication
(10) Pub. No.: US 2002/0045971 A1
(43) Pub. Date: Apr. 18, 2002

(54) Passive RF-RF start system for vehicles

(75) Inventor: Patrick A. Banas, Sterling Heights, MI (US)

Correspondence Address: LAURA M. SLENZAK, SIEMENS CORPORATION, 186 WOOD AVENUE SOUTH, ISELIN, NJ, 08830, US

(73) Assignee: Siemens Automotive Corporation

(21) Appl. No.: 09/932,800

(22) Filed: Aug. 17, 2001

Related U.S. Application Data
(60) Provisional application No. 60/227,409, filed on Aug. 23, 2000.

(51) Int. Cl. B60R 25/00

(52) U.S. Cl. 701/1; 340/426

(57) ABSTRACT

A system for preventing unauthorized operation of a vehicle having a passive entry/start system that uses a bidirectional radio frequency, or RF-RF, signal is disclosed. When using a RF-RF signal system, the signal from vehicle to a driver's ID device is non-directional and not significantly distance limited. Consequently, a thief can activated the entry/start system and gain access to the vehicle when the driver's ID device is simply within range. The inventive passive entry/start system requests a response or a series of responses from a valid nearby driver ID device following startup of the vehicle. A series of valid responses from the ID device is a condition for keeping the vehicle running. In the event that the ID device is not detected after vehicle startup, then it is assumed that the vehicle is being operated by an unauthorized driver and the engine would be shut down before the vehicle was driven very far.

### RELATED APPLICATION

The present application claims priority to U.S. Provisional patent application Serial No. 60/227,409 filed Aug. 23, 2000.

### BACKGROUND OF THE INVENTION

This invention relates to a system for preventing unauthorized operation of a vehicle having a passive entry/start system, and in particular one that uses a bi-directional radio frequency, or RF-RF, signal.

Moderm vehicles are becoming equipped with passive entry/start systems whereby an authorized vehicle operator carries an electronic key or card that contains electronic identifying information. The entry system of the vehicle responds accordingly when the presence of the electronic identifying information, or ID device, is detected. Essentially, these passive systems do not require actuation of any lock, nor the use of any key. Instead, when the operator attempts to pull the door handle open, the vehicle interrogates the area around the vehicle to determine whether a valid ID device is detected. If so, then the door is opened, the ignition started, etc.

Typically, these passive entry/start systems employ a low frequency-radio frequency or LF-RF signal system. That is, the transmission sent from the vehicle to the ID device uses a low frequency (LF) signal and the transmission from the ID device to the vehicle is sent using a radio frequency (RF) signal. The LF signal is directional, and distance limited signal.

While the LF-RF signal systems perform well, they are expensive in comparison with RF-RF signal systems considered for use in passive entry/start systems. A RF-RF signal system can be less expensive because there are fewer antennas required than the LF-RF signal system. The LF-RF signal system usually needs antennas at each entry point, such as doors and the trunk, and also in the interior for starting. Further, the RF-RF signal system uses a less expensive type of antenna.

The use of a RF-RF signal system in passive entry/start systems, however, presents a challenge in that the signal from the vehicle to the ID device is neither directional, nor significantly distance limited. This can create problems in which a thief can activate the system (by pulling on the door handle, closing a switch, mechanical or capacitive sensing, etc.) and gain unauthorized access to the vehicle when the ID device is left within range (eg: ID device in house and vehicle parked close to house) or when the ID device is left within the vehicle. If the ID device is within range, the thief could enter the car, start the car, and drive away. It would therefore be desirable to provide a passive entry/start system for use in vehicles with a less cost prohibitive bi-directional radio frequency signal that also would not be subject to unauthorized vehicle access and operation.

### SUMMARY OF THE INVENTION

In a disclosed embodiment of this invention, a method is devised to prevent unauthorized operation of a vehicle equipped with a bi-directional radio frequency, or RF-RF, signal passive entry/start system. The method comprises a system to interrogate the driver's ID device following start up of the vehicle. This would be a condition for keeping the vehicle running. If no ID signal is received by the vehicle's passive entry/start signal receiver, then the vehicle's engine would shut down to deter a thief from driving far away. Preferably, the interrogations are repeated for a period of time after start up, and movement of the vehicle. After one, or a series of successful interrogations, the process then stops.

These and other features of the present invention can be understood from the following specification and drawings, the following of which is a brief description.

### BRIEF DESCRIPTION OF THE DRAWINGS

FIG. 1 is a schematic diagram of a first instance of the passive entry/start system of the present invention.

FIG. 2 is a schematic diagram of a second instance of the passive entry/start system of the present invention.

### DETAILED DESCRIPTION OF THE DRAWINGS

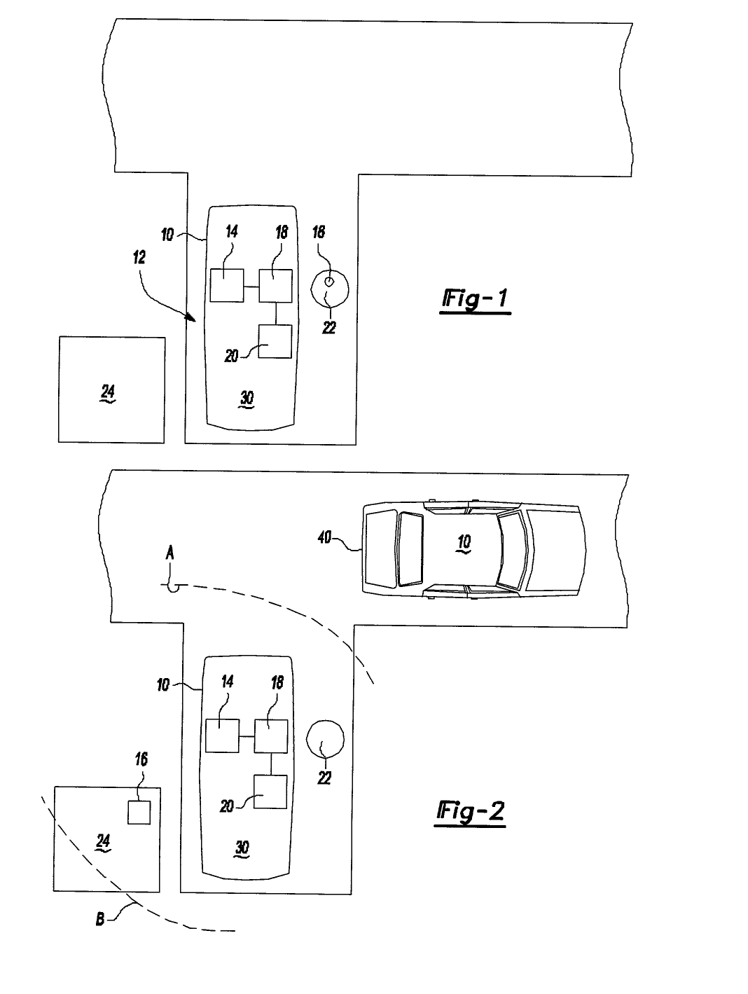

FIG. 1 schematically shows vehicle 10 incorporating the inventive passive entry/start system shown generally at 12. Passive entry/start system 12 uses a bi-directional radio frequency or R-F-RF signal and incorporates a method to prevent unauthorized operation of the vehicle 10. To accomplish this, at a time following passive vehicle entry and startup, the vehicle's signal receiver 14 would request a response or a series of responses from any valid nearby driver ID device. The receiving of valid responses by signal receiver 14 from ID device 16 is a condition for keeping the vehicle 10 running. In the event that ID device 16 is not detected after vehicle startup in response to one or a series of interrogations from signal receiver 14, then it is assumed that vehicle 10 is being operated by an unauthorized driver and a signal is transmitted to engine control unit 18 which, in turn, shuts down vehicle engine 20 before the vehicle is driven very far.

In FIG. 1 vehicle driver 22 is in possession of ID device 16. Therefore, as driver 22 operates vehicle 10, signal receiver 14 repeatedly is able to detect the presence of ID device 16 and vehicle operation is allowed to continue.

In FIG. 2, the vehicle driver 22 is unauthorized. ID device 16 is in the home 24 of the authorized driver.

If a longer range RF device is used on the vehicle 10, the ID device 16 may still be within range. Thus, when an unauthorized driver 32 attempts to open the door of the vehicle or start the vehicle, the vehicle signal receiver 14 interrogates the area. The ID device 16 may well be within range. Thus, the door will be opened, the ignition started, etc. The vehicle can then be started and driven away.

The vehicle 10 is in the driveway 30 but adjacent the home. As the vehicle is driven away, the signal range for ID device 16 which is denoted by A falls out of the signal range for the vehicle's signal receiver 14 which is denoted by B. At the point in time when an interrogation from signal receiver 14 is met with no response from ID device 16, a signal is then transmitted to engine control unit 18 which shuts down vehicle engine 20 in order to prevent the unauthorized driver from driving very far away. That is, when the vehicle moves to a point such as shown at 40, it will be out of range and the engine will be stopped. Thus, preferably, the interrogation continues for a period of time even after movement of the vehicle. After one, or a series of successful interrogations, the process then stops.

Although this inventive system is most applicable to RF-RF signal systems, it may also be used with other signal systems such as LF-RF, LF-LF, microwave, etc.

A preferred embodiment of this invention has been disclosed, however, a worker in this art would recognize that certain modifications would come within the scope of this invention. For that reason, the following claims should be studied to detennine the true scope and content of this invention.

What is claimed is:

1. A passive entry/start system for a vehicle comprising:
a signal receiver within a vehicle, and operable upon certain requests from a potential vehicle operator for sending an interrogation in the area around a vehicle to check for the presence of a valid ID, and to receive a signal from said valid ID; and
said signal receiver being programmed to continue to send signals to interrogate for a valid ID for a period of time after start-up of the vehicle.

2. A passive entry/start system as recited in claim 1 wherein said system includes an engine control unit that receives a signal from said signal receiver to shut down the vehicle's engine in the event that the ID device does not respond to said requests from said signal receiver which indicates unauthorized operation of said vehicle.

3. A passive entry/start system as recited in claim 2 wherein a series of valid responses from said ID device after the vehicle begins moving is a condition for keeping the vehicle's engine running.

4. A passive entry/start system as recited in claim 1, wherein said signal receiver sends a radio frequency signal to said ID device.

5 . A passive entry/start system for a vehicle that uses a bi-directional radio frequency signal between the vehicle and a driver's ID device and incorporates a system for preventing unauthorized operation of said vehicle comprising:
a signal receiver within said vehicle that requests a response or a series of responses from the ID device after the vehicle has been started,
an engine control unit that receives a signal from said signal receiver to shut down the vehicle's engine in the event that the ID device does not respond to said requests from said signal receiver which indicates unauthorized operation of said vehicle.

6. A passive entry/start system as recited in claim 4, wherein a series of valid responses from said ID device is a condition for keeping the vehicle's engine running.

7. A passive entry/start system as recited in claim 5, wherein said signal receiver continues to send said request even after the vehicle has begun to move.

8. A method for preventing unauthorized operation of a vehicle having a passive entry system that uses a bidirectional radio frequency signal comprising the steps of:
requesting a response or a series of responses from a driver's ID device by a signal receiver within said vehicle at a time following the startup of said vehicle, and
activating an engine control unit to shut down the engine of said vehicle in the event that said ID device does not respond to said requests from said signal receiver which indicates unauthorized operation of said vehicle.

9. A method for preventing unauthorized operation of a vehicle as recited in claim 6 wherein a series of valid responses from said ID device is a condition for keeping the vehicle's engine running.
